(19) United States
(12) Patent Application Publication
(10) Pub. No.: US 2019/0232729 A1
(43) Pub. Date: Aug. 1, 2019

(54) PNEUMATIC TIRE

(71) Applicant: Toyo Tire Corporation, Itami-shi (JP)

(72) Inventor: Sachio Sakamoto, Itami-shi (JP)

(73) Assignee: Toyo Tire Corporation, Itami-shi (JP)

(21) Appl. No.: 16/256,364

(22) Filed: Jan. 24, 2019

(30) Foreign Application Priority Data
Jan. 31, 2018 (JP) 2018-015815

(51) Int. Cl. B60C 11/13; B60C 11/01; B60C 13/02; B60C 11/04

(52) U.S. Cl. CPC B60C 11/1315; B60C 11/01; B60C 2011/0346; B60C 11/042; B60C 13/02

(57) ABSTRACT

A pneumatic tire comprises a plurality of main grooves extending in a tire circumferential direction, and a plurality of land portions that are partitioned by at least one contact patch end and the plurality of main grooves, at least one of the land portions comprises a protruding region that protrudes from a tread profile, a beveled region that is arranged at an end in a tire width direction of the at least one land portion, and a connecting surface that connects a surface of the protruding region and a surface of the beveled region and that is arranged so as to be parallel to a line drawn normal to the tread profile.

### CROSS REFERENCE TO RELATED APPLICATIONS

This application claims the benefit of priority of Japanese application no. 2018-15815, filed on Jan. 31, 2018, which is incorporated herein by reference.

### BACKGROUND OF THE INVENTION

### Field of the Invention

The present invention relates to a pneumatic tire.

### Description of the Related Art

Conventionally a pneumatic tire might, for example, comprise a plurality of main grooves extending along the tire circumferential direction, and a plurality of land portions which are partitioned by contact patch ends and the plurality of main grooves. In addition, a land portion might comprise a protruding region that protrudes from the tread profile, and a beveled region that is arranged at an end in the tire width direction of the land portion (e.g., JP-A 2012-106608). It so happens that there has been demand in recent years for tires capable of being used in all seasons. More specifically, there is demand for a tire that excels not only in stability in handling under dry conditions but that also excels in stability in handling in snow.

### SUMMARY OF THE INVENTION

The problem is therefore to provide a pneumatic tire that will make it possible to improve not only stability in handling during turns under dry conditions but also stability in handling during turns in snow.

There is provided a pneumatic tire comprises:

a plurality of main grooves extending in a tire circumferential direction; and

a plurality of land portions that are partitioned by at least one contact patch end and the plurality of main grooves;

wherein at least one of the land portions comprises a protruding region that protrudes from a tread profile, a beveled region that is arranged at an end in a tire width direction of the at least one land portion, and a connecting surface that connects a surface of the protruding region and a surface of the beveled region and that is arranged so as to be parallel to a line drawn normal to the tread profile.

Further, the pneumatic tire may have a configuration in which:

the beveled region is one of two beveled regions that are arranged at respective ends toward the exterior in the tire width direction of a pair of the land portions that are arranged in next-to-outwardmost fashion in the tire width direction.

Further, the pneumatic tire may have a configuration in which:

the pneumatic tire is a pneumatic tire for which a vehicle mounting orientation is indicated, and comprises an indicator region that indicates an orientation in which the pneumatic tire is to be mounted on the vehicle; and

the beveled region is arranged at an end which is toward the exterior when the pneumatic tire is mounted on the vehicle of that land portion which of the plurality of land portions is arranged in next-to-outwardmost fashion when the pneumatic tire is mounted on the vehicle.

Further, the pneumatic tire may have a configuration in which:

the surface of the beveled region is formed so as to be curved in such fashion as to present a convex appearance to the exterior in a tire radial direction.

Further, the pneumatic tire may have a configuration in which:

the surface of the beveled region is formed in planar fashion.

Further, the pneumatic tire may have a configuration in which:

a dimension in a direction of the line drawn normal to the tread profile of the connecting surface is less than a maximum value of an amount by which the protruding region protrudes from the tread profile.

Further, the pneumatic tire may have a configuration in which:

a dimension in a direction of the line drawn normal to the tread profile of the connecting surface is less than a maximum value of an amount by which the beveled region is recessed relative to the tread profile.

Further, the pneumatic tire may have a configuration in which:

a maximum value of an amount by which the beveled region is recessed relative to the tread profile is greater than a maximum value of an amount by which the protruding region protrudes from the tread profile.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing a tread surface of a pneumatic tire associated with same embodiment as they would exist if unwrapped so as to lie in a single plane;

FIG. 3 is a schematic cross-sectional view, taken along a tire meridional plane, of the principal components in a pneumatic tire associated with same embodiment;

FIG. 4 is a drawing showing a tread surface associated with a modified example as they would exist if unwrapped so as to lie in a single plane;

FIG. 5 is a view of a section, taken along a tire meridional plane, of the principal components in a tread region associated with another modified example;

FIG. 6 is a view of a section, taken along a tire meridional plane, of the principal components in a tread region associated with same embodiment;

FIG. 7 is a view of a section, taken along a tire meridional plane, of the principal components in a tread region associated with same embodiment;

FIG. 8 is a view of a section, taken along a tire meridional plane, of the principal components at a tread region associated with same embodiment in a drawing showing a situation that might exist when driving straight ahead on a dry road surface;

FIG. 9 is a view of a section, taken along a tire meridional plane, of the principal components at a tread region associated with same embodiment in a drawing showing a situation that might exist when turning on a dry road surface;

FIG. 10 is a view of a section, taken along a tire meridional plane, of the principal components at a tread region associated with same embodiment in a drawing showing a situation that might exist when turning on a road surface with snow;

FIG. 11 is a view of a section, taken along a tire meridional plane, of the principal components in a tread region associated with another embodiment; and

FIG. 12 is a view of a section, taken along a tire meridional plane, of the principal components in a tread region associated with yet another embodiment.

### DETAILED DESCRIPTION OF THE INVENTION

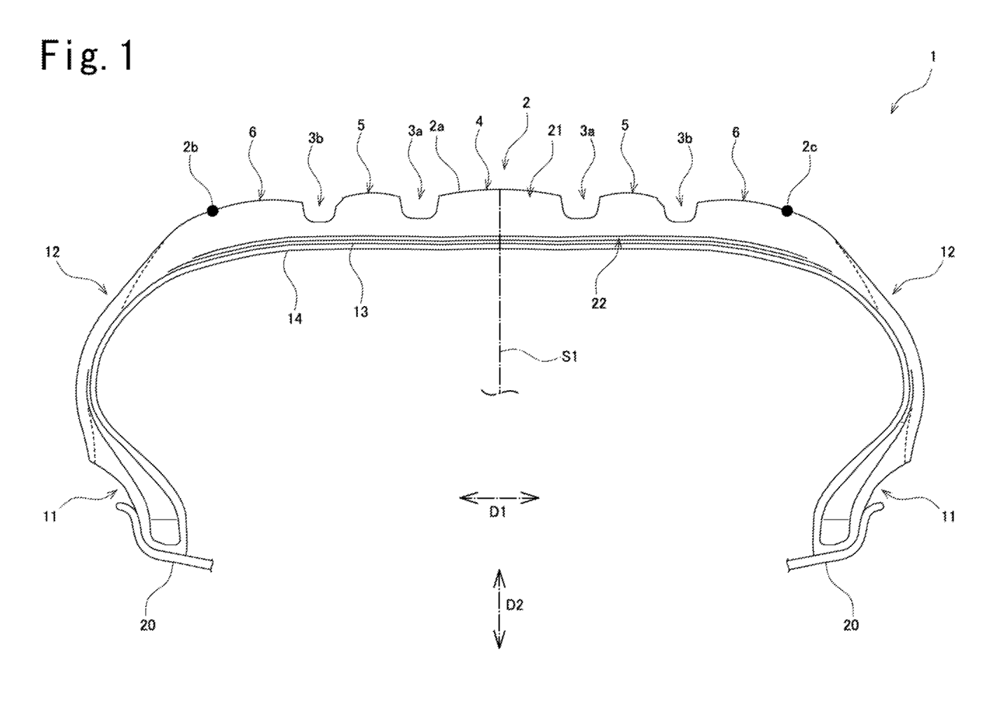

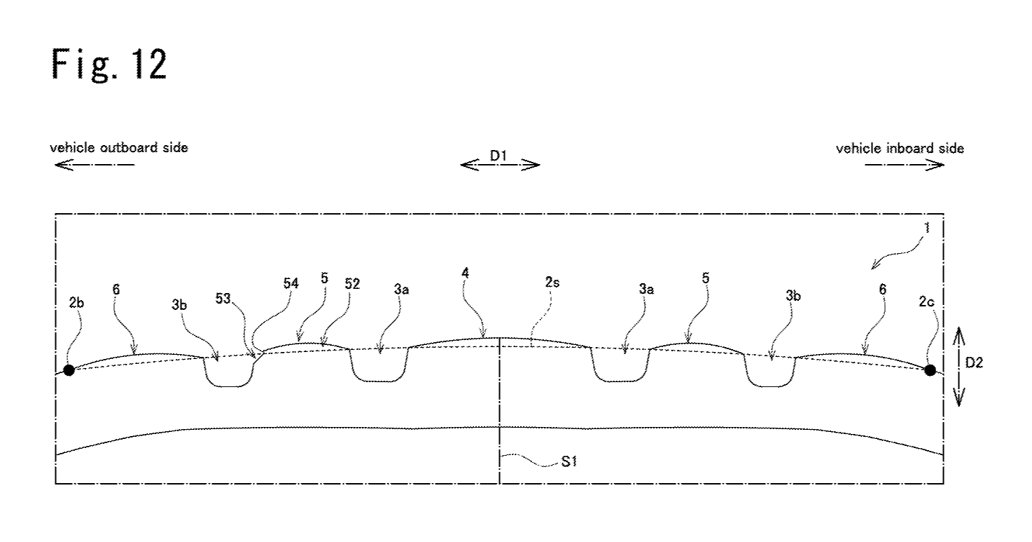

Below, an embodiment of a pneumatic tire is described with reference to FIG. 1 through FIG. 10. At the respective drawings (and the same is true for FIG. 11 and FIG. 12), note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

As shown in FIG. 1, tire 1 associated with the present embodiment is provided with a pair of bead regions 11 at which beads are present; sidewall regions 12 which extend outwardly in the tire radial direction D2 from the respective bead regions 11; and tread region 2, the exterior surface in the tire radial direction D2 of which contacts the road surface and which is contiguous with the outer ends in the tire radial direction D2 of the pair of sidewall regions 12. In accordance with the present embodiment, tire 1 is a pneumatic tire 1, the interior of which is capable of being filled with air, and which is capable of being mounted on a rim 20.

Furthermore, tire 1 is provided with carcass layer 13 which spans the pair of beads, and innerliner layer 14 which is arranged at a location toward the interior from carcass layer 13 and which has superior functionality in terms of its ability to impede passage of gas therethrough so as to permit air pressure to be maintained. Carcass layer 13 and innerliner layer 14 are arranged in parallel fashion with respect to the inner circumferential surface of the tire over a portion thereof that encompasses bead regions 11, sidewall regions 12, and tread region 2.

Tread region 2 is provided with tread rubber 21 having tread surface 2a which contacts the road surface, and belt region 22 which is arranged between tread rubber 21 and carcass layer 13. Present at tread surface 2a is the contact patch that actually comes in contact with the road surface, and the portions within said contact patch that are present at the outer ends in the tire width direction D1 are referred to as contact patch ends 2b, 2c. Note that said contact patch refers to the portion of the tread surface 2a that comes in contact with the road surface when a normal load is applied to a tire 1 mounted on a normal rim 20 when the tire 1 is inflated to normal internal pressure and is placed in vertical orientation on a flat road surface.

Normal rim 20 is that particular rim 20 which is specified for use with a particular tire 1 in the context of the body of standards that contains the standard that applies to the tire 1 in question, this being referred to, for example, as a standard rim in the case of JATMA, a “Design Rim” in the case of TRA, or a “Measuring Rim” in the case of ETRTO.

Normal internal pressure is that air pressure which is specified for use with a particular tire 1 in the context of the body of standards that contains the standard that applies to the tire 1 in question, this being maximum air pressure in the case of JATMA, the maximum value listed at the table entitled “TIRE LOAD LIMITS AT VARIOUS COLD INFLATION PRESSURES” in the case of TRA, or “INFLATION PRESSURE” in the case of ETRTO, which when tire 1 is to used on a passenger vehicle is taken to be an internal pressure of 180 KPa.

Normal load is that load which is specified for use with a particular tire 1 in the context of the body of standards that contains the standard that applies to the tire 1 in question, this being maximum load capacity in the case of JATMA, the maximum value listed at the aforementioned table in the case of TRA, or “LOAD CAPACITY” in the case of ETRTO, which when tire 1 is to be used on a passenger vehicle is taken to be 85% of the load corresponding to an internal pressure of 180 KPa.

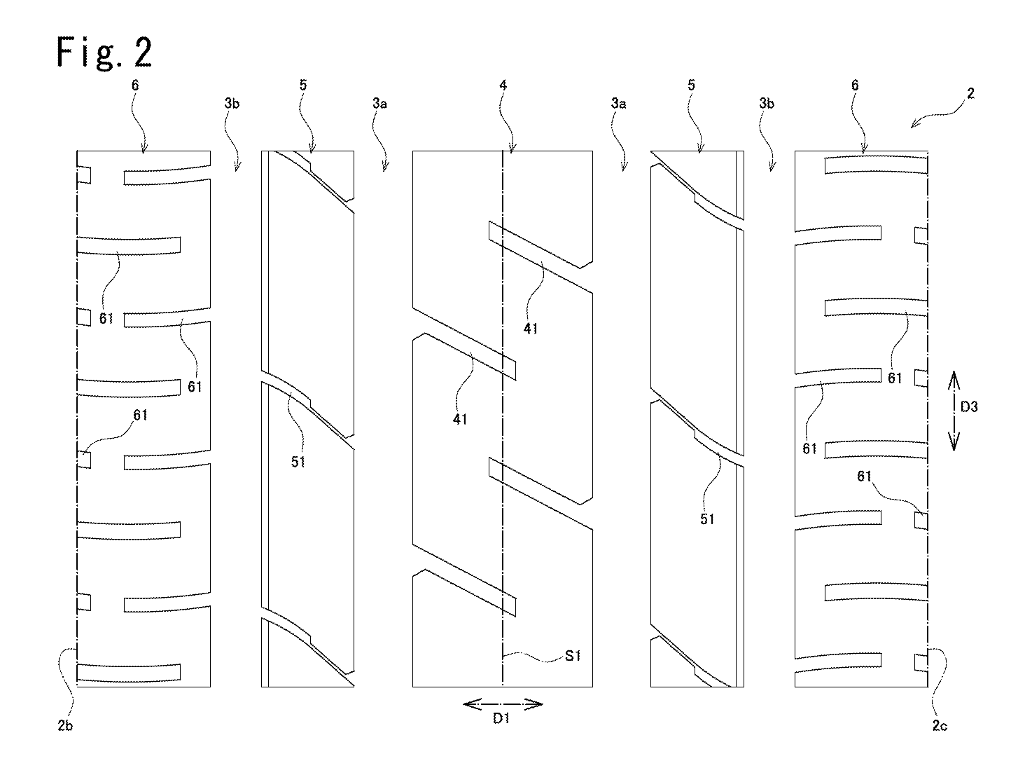

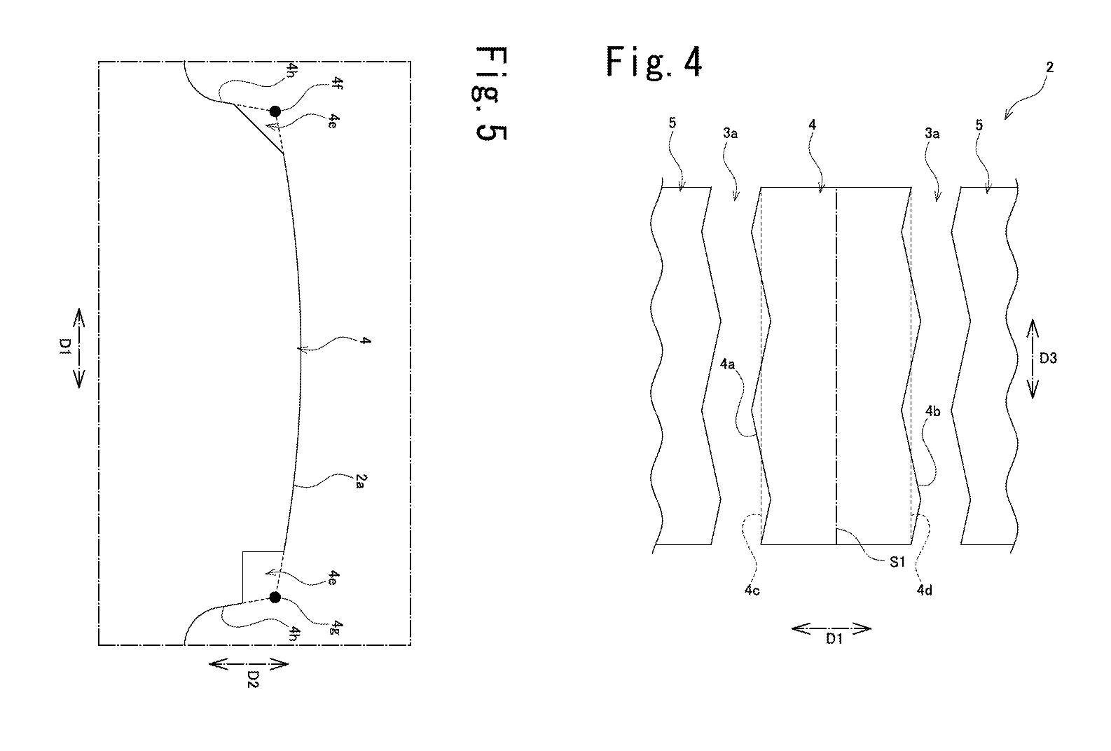

As shown in FIG. 1 and FIG. 2, tread rubber 21 is provided with a plurality of main grooves 3a, 3b extending in the tire circumferential direction D3. Main groove 3a, 3b extends continuously in the tire circumferential direction D3. Note that whereas main grooves 3a, 3b extend in straight fashion in the tire circumferential direction D3 in the present embodiment, there is no limitation with respect to such constitution, it also being possible to adopt a constitution in which these are, for example, repeatedly bent such that they extend in zigzag fashion (see FIG. 4), or a constitution in which these are, for example, repeatedly curved such that they extend in wavy fashion.

Main groove 3a, 3b might, for example, be provided with so-called tread wear indicator(s) (not shown) which are portions at which depth of the groove is reduced so as to make it possible to ascertain the extent to which wear has occurred as a result of the exposure thereof that takes place in accompaniment to wear. Furthermore, main groove 3a, 3b might, for example, have a width that is not less than 3% of the distance (dimension in the tire width direction D1) between contact patch ends 2b, 2c. Furthermore, main groove 3a, 3b might, for example, have a width that is not less than 5 mm.

All of the main grooves 3a, 3b are separated from tire equatorial plane S1. In addition, at the plurality of main grooves 3a, 3b, the pair of main grooves 3a, 3a arranged so as to straddle tire equatorial plane S1 which is at the center in the tire width direction D1 of tire 1 are referred to as center main grooves 3a, 3a; and main groove(s) 3b arranged toward the exterior in the tire width direction D1 from center main groove(s) 3a are referred to as shoulder main groove(s) 3b.

Tread rubber 21 comprises a plurality of land portions 4 through 6 which are partitioned by main groove 3a, 3b and contact patch ends 2b, 2c. At the plurality of land portions 4 through 6, land portion 4 containing the tire equatorial plane S1 which is at the center in the tire width direction D1 is referred to as center land portion 4; the pair of land portions 5, 5 which are adjacent in the tire width direction D1 to center land portion 4 are referred to as mediate land portions 5, 5; and the pair of land portions 6, 6 arranged in outwardmost fashion in the tire width direction D1 are referred to as shoulder land portions 6, 6.

Center land portion 4 is partitioned by the pair of center main grooves 3a, 3a that are arranged so as to straddle tire equatorial plane S1 which is at the center in the tire width direction D1. Mediate land portion 5 is partitioned by center main groove 3a and shoulder main groove 3b. Shoulder land portion 6 is partitioned by shoulder main groove 3b and contact patch end 2b, 2c.

In accordance with the present embodiment, the constitution is such that the number of main grooves 3a, 3b that are present is four, and the number of land portions 4 through 6 that are present is five. There is no particular limitation, however, with respect to the number of main grooves 3a, 3b or the number of land portions 4 through 6.

Land portions 4 through 6 comprise a plurality of land grooves 41, 51, 61. In accordance with the present embodiment, land grooves 41, 51, 61 are grooves (also referred to as “width grooves”) that extend in such fashion as to intersect the tire circumferential direction D3. Note that land groove(s) may include groove(s) (also referred to as “circumferential groove(s)”) that are narrower than main groove(s) 3a, 3b and that extend continuously along the tire circumferential direction D3, and/or groove(s) that extend intermittently along the tire circumferential direction D3.

Tread rubber 21 comprises a tread pattern formed by main groove 3a, 3b and land grooves 41, 51, 61. In accordance with the present embodiment, tire 1 employs a symmetric tread pattern for which no vehicle mounting orientation is indicated. The tread pattern at FIG. 2 is a tread pattern that exhibits point symmetry about an arbitrary point on the tire equator. As a symmetric tread pattern for which no vehicle mounting orientation is indicated, note that tire 1 may employ a line-symmetric tread pattern exhibiting symmetry about the tire equator.

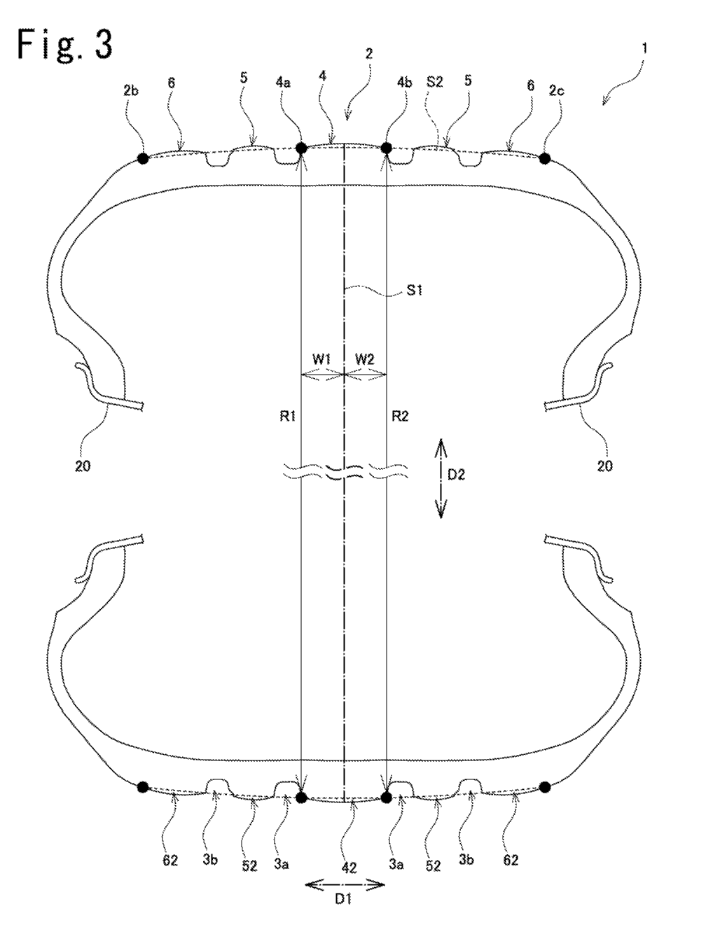

The constitutions of land portions 4 through 6 will now be described with reference to FIG. 3 through FIG. 7.

As shown in FIG. 3, tread profile S2 which serves as tire reference outline is present toward the outside surface in the tire radial direction D2 of tread region 2. As viewed in a tire meridional section, tread profile S2 is curved in such fashion as to present a convex appearance to the exterior in the tire radial direction D2. Tread profile S2 may be defined as that single circular arc which when tire 1 mounted on normal rim 20 and inflated to normal internal pressure under no load is viewed in a tire meridional section (section along the tire radial direction D2) contains the three points constituted by the pair of contact patch ends 2b, 2c and reference end edge 4a (4b) of center land portion 4.

Note that reference end edge 4a (4b) of center land portion 4 is that end edge 4a (4b) for which, of the pair of end edges 4a, 4b in the tire width direction D1 of center land portion 4, the distance W1, W2 between it and the center (tire equatorial plane S1) in the tire width direction D1 is less than that of the other. Furthermore, in the event that said distances W1, W2 are the same, reference end edge 4a (4b) of center land portion 4 is that end edge 4a (4b) for which the tire outside diameter R1, R2 is less than that of the other.

Furthermore, as shown in FIG. 4, in the context of a configuration in which center main groove 3a extends in zigzag-like fashion, reference end edge 4c (4d) of center land portion 4 is the equivalent end edge 4c (4d). Note that equivalent end edge 4c, 4d may be determined based on the average location in the tire width direction D1 of end edge 4a, 4b.

Furthermore, as shown in FIG. 5, in the context of a configuration in which center land portion 4 comprises notch(es) 4e at the ends thereof, reference end edge 4f (4g) of center land portion 4 is the equivalent end edge 4f (4g). Note that equivalent end edge 4f, 4g may be determined based on the intersection of the imaginary line (shown in broken line at FIG. 5) which is the extension of tread surface 2a of center land portion 4 and the imaginary line (shown in broken line at FIG. 5) which is the extension of end face 4h to one (or the other) side in the tire width direction D1 of center land portion 4.

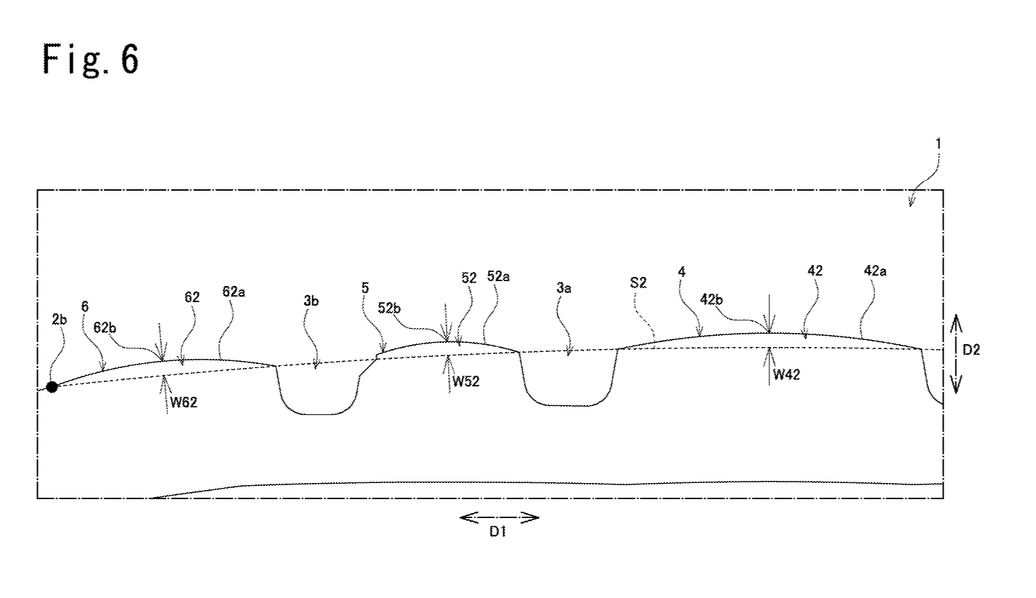

As shown in FIG. 6, tread surfaces 2a of all land portions 4 through 6 are located toward the exterior in the tire radial direction D2 from tread profile S2. That is, each land portion 4 through 6 comprises a protruding region 42, 52, 62 (hereinafter sometimes written as “42 through 62”) that protrudes toward the exterior in the tire radial direction D2 from tread profile S2. At the respective drawings, note that protruding regions 42 through 62 are drawn in exaggerated fashion.

It is, for example, preferred that the maximum values of protruding amounts W42 through W62 of respective protruding regions 42 through 62 be 0.1 mm to 0.5 mm. Here, protruding amounts W42 through W62 refer to the amount of protrusion, in a direction normal to tread profile S2, from tread profile S2.

Furthermore, as viewed in a tire meridional section, surfaces 42a through 62a of each protruding regions 42 through 62 are formed so as to be curved in such fashion as to present a convex appearance to the exterior in the tire radial direction D2. This being the case, the locations at surfaces 42a through 62a at which protruding amounts W42 through W62 of protruding regions 42 through 62 are maxima, i.e., peaks 42b through 62b of protruding regions 42 through 62, will be arranged at locations intermediate in the tire width direction D1 within land portions 4 through 6.

In addition, protruding amounts W42 through W62 of protruding regions 42 through 62 decrease as one proceeds from peaks 42b through 62b toward the ends in the tire width direction D1 of land portions 4 through 6. Moreover, as viewed in a tire meridional section, it is, for example, preferred that the radii of curvature of surfaces 42a through 62a of land portions 4 through 6 be 100 mm to 5000 mm.

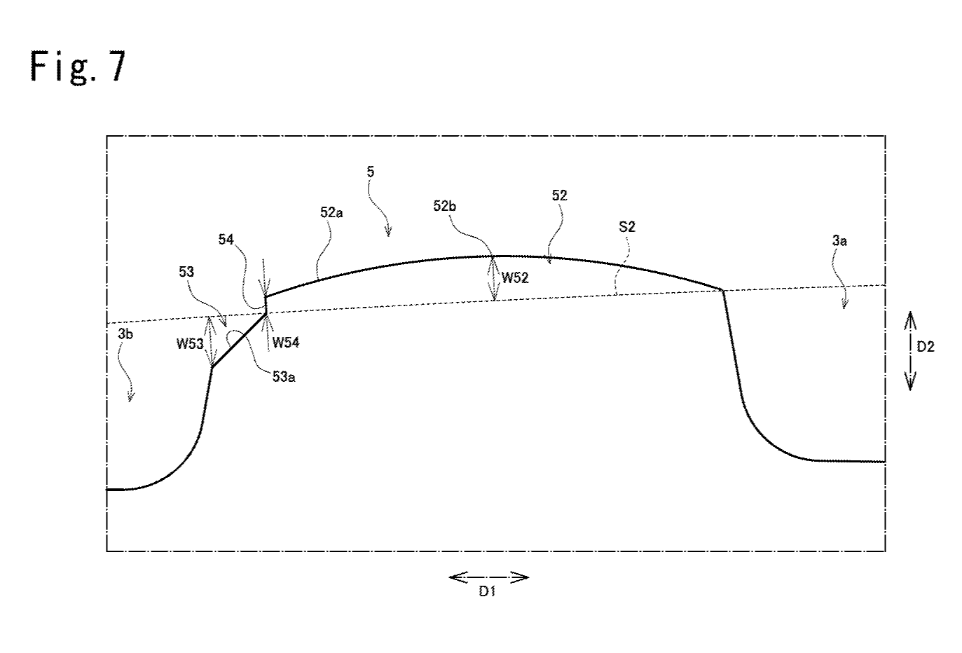

As shown in FIG. 7, mediate land portion 5 comprises beveled region 53 which is arranged at an end toward the exterior in the tire width direction D1. Furthermore, mediate land portion 5 comprises connecting surface 54 which connects surface 52a of protruding region 52 and surface 53a of beveled region 53. What is referred to herein such as a beveled region 53 is a region having a surface 53a that makes a nonzero angle with an end face (e.g., see end face 4h at FIG. 5) of a land portion 4 through 6.

In accordance with the present embodiment, a beveled region 53 is arranged at the end toward the exterior in the tire width direction D1 of each of the pair of mediate land portions 5 (see FIG. 3). In addition, surface 53a of beveled region 53 is formed in planar fashion. Although surface 53a of beveled region 53 is formed in planar fashion in the present embodiment, there is no particular limitation with respect thereto, it being sufficient that there be a nonzero angle between surface 53a and end face (e.g., see end face 4h at FIG. 5) of a land portion 4 through 6; for example, in some embodiments, surface 53a of beveled region 53 may be formed in curved fashion.

As viewed in a tire meridional section, connecting surface 54 is arranged so as to be parallel to a line drawn normal to tread profile S2. Here, what is meant by a line drawn normal to tread profile S2 is a line drawn normal to tread profile S2 at the location where tread profile 52 intersects connecting surface 54. Note that where connecting surface 54 is separated from tread profile S2, this is understood to mean a line drawn so as to be normal to tread profile S2 and so as to pass through that endpoint of connecting surface 54 which is nearer to tread profile S2 as viewed in a tire meridional section.

In addition, as viewed in a tire meridional section, it is, for example, preferred that the angle at which connecting surface 54 intersects a line drawn normal to tread profile S2 be not greater than 10°, and more preferred that this be not greater than 5°. Moreover, connecting surface 54 is arranged so as to face the exterior in the tire width direction D1.

Note that there is no particular limitation with regard to the maximum value of the amount W52 by which protruding region 52 protrudes, the maximum value of the amount W53 by which beveled region 53 is recessed, or dimension W54 in the direction of a line drawn normal to tread profile S2 of connecting surface 54. Note that recessed amount W53 of beveled region 53 refers to the amount by which this is recessed, in a direction normal to tread profile S2, from tread profile S2.

It is, for example, preferred that dimension W54 in the direction of a line drawn normal to tread profile S2 of connecting surface 54 be less than the maximum value of the amount W52 by which protruding region 52 protrudes and less than the maximum value of the amount W53 by which beveled region 53 is recessed. It is, for example, preferred that said dimension W54 of connecting surface 54 be 0.05 mm to 0.2 mm.

Furthermore, it is, for example, preferred that the maximum value of the amount W53 by which beveled region 53 is recessed be greater than the maximum value of the amount W52 by which protruding region 52 protrudes. It is, for example, preferred that the maximum value of the amount W53 by which beveled region 53 is recessed be 1 mm to 3 mm.

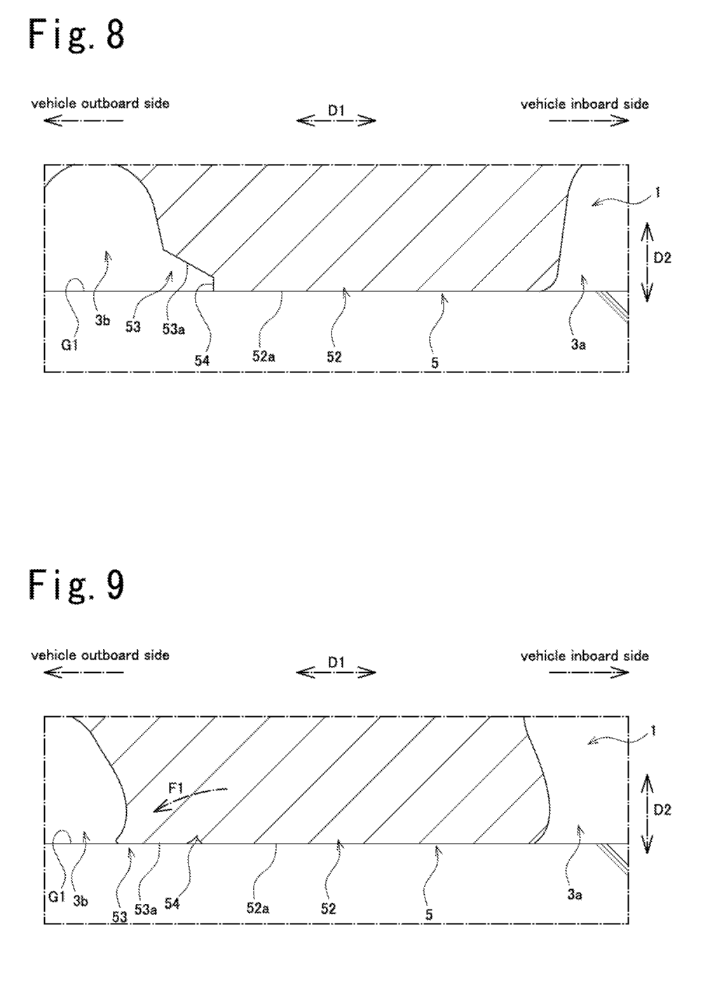

Constitution of tire 1 associated with the present embodiment is as described above; action of tire 1 associated with the present embodiment is described below with reference to FIG. 8 through FIG. 10.

When tire 1 comes in contact with the ground, there is ordinarily an increasing tendency for land portions 4 through 6 to deform so as to become compressed as one proceeds toward locations intermediate in the tire width direction D1. For this reason, because there is, for example, a tendency for buckling to occur at locations intermediate in the tire width direction D1 of land portions 4 through 6, there is a tendency for locations (e.g., central locations) intermediate in the tire width direction D1 of land portions 4 through 6 not to come in contact with the ground.

At tire 1 associated with the present embodiment, protruding amounts W42 through W62 of protruding regions 42 through 62 are therefore made to decrease as one proceeds from peaks 42b through 62b, which are arranged at locations intermediate in the tire width direction D1, toward the ends in the tire width direction D1 of land portions 4 through 6. As a result, e.g., as shown in FIG. 8, when the vehicle is going straight ahead on dry road surface G1, it is possible to cause locations intermediate in the tire width direction D1 at protruding regions 42 through 62 (note that only protruding region 52 of mediate land portion 5 is shown at FIG. 8) to definitively come in contact with the ground.

In addition, when the vehicle is turning on dry road surface G1 about a turning center toward the vehicle inboard side (i.e., toward the interior when the tire is mounted on the vehicle), because a force F1 in the direction of the vehicle outboard side (i.e., toward the exterior when the tire is mounted on the vehicle) will act on land portion 5 as shown in FIG. 9, land portion 5 deforms in such fashion as to collapse in the tire width direction D1. At such time, land portion 5 deforms in such fashion as to collapse toward the vehicle outboard side while surface 52a of protruding region 52 remains in contact with the ground.

As a result, not only surface 52a of protruding region 52 but also surface 53a of beveled region 53 will be in contact with the ground. Accordingly, because area that comes in contact with the road surface at land portion 5 increases, it is possible to improve stability in handling during turns under dry conditions.

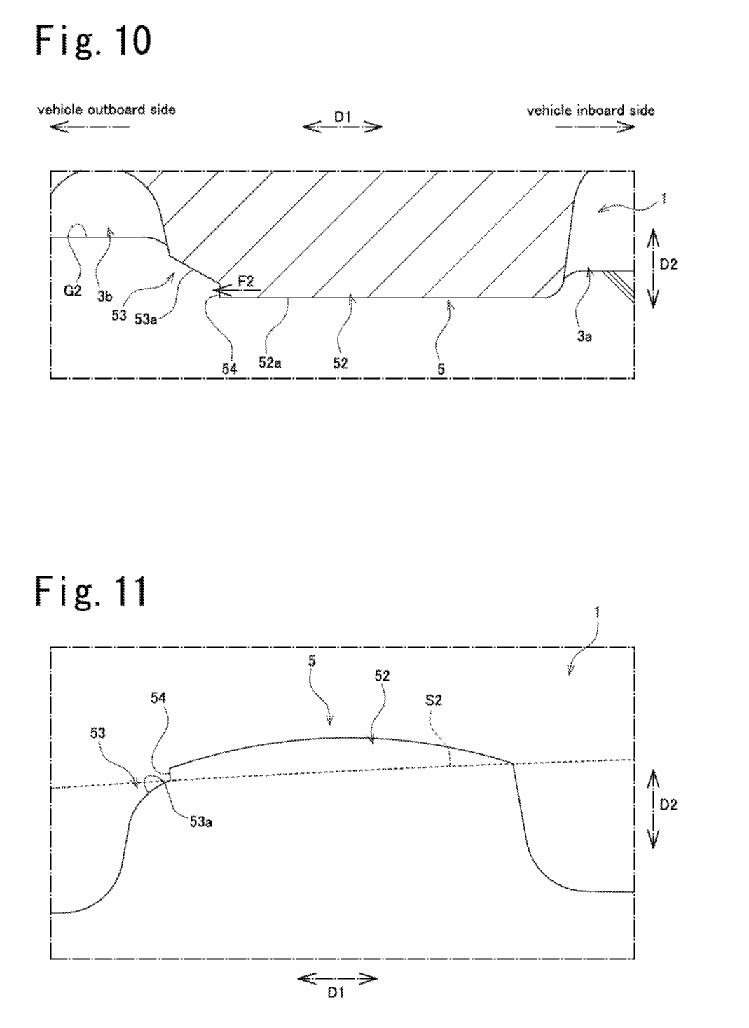

On the other hand, when the vehicle is turning on snowy road surface G2 about a turning center toward the vehicle inboard side, connecting surface 54 might, e.g. as shown in FIG. 10, cause a force F2 to be exerted toward the vehicle outboard side in such fashion as to be directed toward the snow such that the plane thereof pushes on the snow and/or such that the snow is borne by the plane thereof, for example. Moreover, the edge of connecting surface 54 might, for example, shear the snow. This will make it possible to improve stability in handling during turns in snow.

It so happens that, as should be clear from the foregoing action, causing beveled region 53 to be located at an end which among the ends of land portions 4 through 6 is toward the vehicle outboard side, and causing beveled region 53 to be located as far as possible toward the vehicle outboard side, will permit effective improvement in stability in handling during turns under dry conditions. Furthermore, as should be clear from the foregoing action, causing connecting surface 54 to be located such that it faces the vehicle outboard side, and causing connecting surface 54 to be located as far as possible toward the vehicle outboard side, will permit effective improvement in stability in handling during turns in snow.

However, because the end toward the vehicle outboard side at land portion 6, which is the outboardmost thereamong, is a contact patch end 2b (2c), beveled region 53 cannot be arranged at said end (nor can connecting surface 54). Accordingly, for effective improvement of stability in handling during turns under dry conditions and of stability in handling during turns in snow, it is preferred that beveled region 53 (and connecting surface 54) be arranged at the end toward the vehicle outboard side at land portion 5, which is the next-to-outboardmost thereamong.

At tire 1 associated with the present embodiment, beveled regions 53 are therefore arranged at the respective ends toward the exterior in the tire width direction D1 at the pair of mediate land portions 5. By so doing, regardless of the orientation in which tire 1 is mounted on the vehicle, beveled region 53 will be arranged at the end toward the vehicle outboard side at land portion 5, which is the next-to-outboardmost thereamong, and connecting surface 54 will be located such that it faces the vehicle outboard side. Accordingly, it will be possible to effectively improve stability in handling during turns under dry conditions and stability in handling during turns in snow regardless of the orientation in which tire 1 is mounted on the vehicle.

As described above, the pneumatic tire 1 of the embodiment includes: a plurality of main grooves 3a, 3b extending in a tire circumferential direction D3; and a plurality of land portions 4 through 6 that are partitioned by at least one contact patch end 2b, 2c and the plurality of main grooves 3a, 3b; wherein at least one of the land portions 5 comprises a protruding region 52 that protrudes from a tread profile S2, a beveled region 53 that is arranged at an end in a tire width direction D1 of the at least one land portion 5, and a connecting surface 54 that connects a surface 52a of the protruding region 52 and a surface 53a of the beveled region 53 and that is arranged so as to be parallel to a line drawn normal to the tread profile S2.

In accordance with such constitution, when the vehicle is turning on dry road surface G1, land portions 4 through 6 deform in such fashion as to collapse in the tire width direction D1. In addition, because beveled region 53 is arranged at an end in the tire width direction D1 of land portion 5, not only surface 52a of protruding region 52 but also surface 53a of beveled region 53 will be in contact with the ground. Accordingly, because area that comes in contact with the road surface at land portion 5 increases, it is possible to improve stability in handling during turns under dry conditions.

On the other hand, connecting surface 54 is arranged so as to be parallel to a line drawn normal to tread profile S2. As a result, because, when the vehicle is turning on snowy road surface G2, connecting surface 54 is such that the edge thereof shears the snow and such that the snow is pushed on by and/or borne by the plane thereof, it is possible to improve stability in handling during turns in snow.

In the pneumatic tire 1 of the embodiment, the beveled region 53 is one of two beveled regions 53, 53 that are arranged at respective ends toward the exterior in the tire width direction D1 of a pair of the land portions 5, 5 (mediate land portions 5, 5 in this embodiment) that are arranged in next-to-outwardmost fashion in the tire width direction D1.

In accordance with such constitution, regardless of the orientation in which tire 1 is mounted on the vehicle, beveled region 53 will be arranged at an end which is toward the exterior when the tire is mounted on the vehicle of land portion 5, which is the next-to-outwardmost thereamong when the tire is mounted on the vehicle; and connecting surface 54 will be located such that it faces the exterior when the tire is mounted on the vehicle. This being the case, beveled region 53 will make it possible to effectively improve stability in handling during turns under dry conditions, and connecting surface 54 will make it possible to effectively improve stability in handling during turns in snow.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that surface 53a of beveled region 53 is formed in planar fashion. However, pneumatic tire 1 is not limited to such constitution. For example, as shown in FIG. 11, it is also possible to adopt a constitution in which surface 53a of beveled region 53 is formed as a surface that is curved in such fashion as to present a convex appearance to the exterior in the tire radial direction D2.

In accordance with the constitution associated with FIG. 11, when the vehicle is turning on dry road surface G1 and surface 53a of beveled region 53 is in contact with the ground, it is possible to suppress occurrence of buckling at locations intermediate in the tire width direction D1 of surface 53a of beveled region 53. This will make it possible to cause the entire surface 53a of beveled region 53 to definitively be made to come in contact with the ground. Accordingly, because area that comes in contact with the road surface at land portion 5 will increase further, it will be possible to further improve stability in handling during turns under dry conditions.

(2) Furthermore, the constitution of pneumatic tire 1 associated with the foregoing embodiment is such that there are two beveled regions 53, these being arranged at the ends toward the exterior in the tire width direction D1 of mediate land portions 5. However, pneumatic tire 1 is not limited to such constitution.

For example, it is also possible to adopt a constitution in which there is one beveled region 53 or there are three or more beveled regions 53. Furthermore, for example, it is also possible to adopt a constitution in which beveled region (s) 53 are arranged at end(s) in the tire width direction D1 of center land portion 4, it is also possible to adopt a constitution in which beveled region(s) 53 are arranged at end(s) toward the interior in the tire width direction D1 of mediate land portion(s) 5, and it is also possible to adopt a constitution in which beveled region(s) 53 are arranged at end(s) toward the interior in the tire width direction D1 of shoulder land portion(s) 6.

(3) Furthermore, the constitution of pneumatic tire 1 associated with the foregoing embodiment is such that this is a tire 1 for which a vehicle mounting orientation is not indicated. However, pneumatic tire 1 is not limited to such constitution. For example, as shown in FIG. 12, it is also possible to adopt a constitution in which pneumatic tire 1 is a tire 1 for which a vehicle mounting orientation is indicated.

The orientation in which the tire is to be mounted on the vehicle might, for example, be indicated at sidewall region 12. More specifically, sidewall region 12 might have an indicator region (not shown). In addition, for example, one sidewall region 12, i.e., that which is to be arranged toward the vehicle inboard side, might be marked (e.g., with the word “INSIDE” or the like) so as to contain an indication to the effect that it is for the vehicle inboard side; and the other sidewall region 12, i.e., that which is to be arranged toward the vehicle outboard side, might be marked (e.g., with the word “OUTSIDE” or the like) so as to contain an indication to the effect that it is for the vehicle outboard side.

In addition, the constitution of pneumatic tire 1 associated with FIG. 12 is a pneumatic tire 1 for which a vehicle mounting orientation is indicated, and comprises an indicator region that indicates an orientation in which the pneumatic tire 1 is to be mounted on the vehicle; and the beveled region 53 is arranged at an end which is toward the exterior when the pneumatic tire 1 is mounted on the vehicle of that land portion 5 which of the plurality of land portions 4 through 6 is arranged in next-to-outwardmost fashion when the pneumatic tire 1 is mounted on the vehicle.

In accordance with the constitution associated with FIG. 12, because the orientation in which tire 1 is to be mounted on the vehicle is indicated, beveled region 53 will be arranged at an end which is toward the exterior when the tire is mounted on the vehicle of land portion 5, which is the next-to-outwardmost thereamong when the tire 1 is mounted on the vehicle. This being the case, beveled region 53 will make it possible to effectively improve stability in handling during turns under dry conditions, and connecting surface 54 will make it possible to effectively improve stability in handling during turns in snow.

(4) Furthermore, the constitution of pneumatic tire 1 associated with the foregoing embodiment is such that protruding amounts W42 through W62 of protruding regions 42 through 62 decrease as one proceeds from a location intermediate in the tire width direction D1 of each of land portions 4 through 6 toward the respective ends in the tire width direction D1 of each of land portions 4 through 6. However, while such constitution is preferred, pneumatic tire 1 is not limited to such constitution.

For example, it is also possible to adopt a constitution in which protruding amounts W42 through W62 of protruding regions 42 through 62 are the same at all locations in the tire width direction D1 of land portions 4 through 6. Furthermore, it is also possible, for example, to adopt a constitution in which protruding amount W42 through W62 of protruding region 42 through 62 decreases as one proceeds from one end to the other end in the tire width direction D1 of land portion 4 through 6.

(5) Furthermore, the constitution of pneumatic tire 1 associated with the foregoing embodiment is such that, when land portion 4 through 6 is divided into three equal regions in the tire width direction D1, peak 42b through 62b of protruding region 42 through 62 is arranged at a location that is in the central region thereamong. However, pneumatic tire 1 is not limited to such constitution. For example, it is also possible to adopt a constitution in which, when land portion 4 through 6 is divided into three equal regions in the tire width direction D1, peak 42b through 62b of protruding region 42 through 62 is arranged at a location that is in the region thereamong which is toward the exterior in the tire width direction D1.

1. A pneumatic tire comprising:
a plurality of main grooves extending in a tire circumferential direction; and
a plurality of land portions that are partitioned by at least one contact patch end and the plurality of main grooves;
wherein at least one of the land portions comprises a protruding region that protrudes from a tread profile, a beveled region that is arranged at an end in a tire width direction of the at least one land portion, and a connecting surface that connects a surface of the protruding region and a surface of the beveled region and that is arranged so as to be parallel to a line drawn normal to the tread profile.

2. The pneumatic tire according to claim 1 wherein the beveled region is one of two beveled regions that are arranged at respective ends toward the exterior in the tire width direction of a pair of the land portions that are arranged in next-to-outwardmost fashion in the tire width direction.

3. The pneumatic tire according to claim 1 wherein
the pneumatic tire is a pneumatic tire for which a vehicle mounting orientation is indicated, and comprises an indicator region that indicates an orientation in which the pneumatic tire is to be mounted on the vehicle; and
the beveled region is arranged at an end which is toward the exterior when the pneumatic tire is mounted on the vehicle of that land portion which of the plurality of land portions is arranged in next-to-outwardmost fashion when the pneumatic tire is mounted on the vehicle.

4. The pneumatic tire according to claim 1 wherein the surface of the beveled region is formed so as to be curved in such fashion as to present a convex appearance to the exterior in a tire radial direction.

5. The pneumatic tire according to claim 1 wherein the surface of the beveled region is formed in planar fashion.

6. The pneumatic tire according to claim 1 wherein a dimension in a direction of the line drawn normal to the tread profile of the connecting surface is less than a maximum value of an amount by which the protruding region protrudes from the tread profile.

7. The pneumatic tire according to claim 1 wherein a dimension in a direction of the line drawn normal to the tread profile of the connecting surface is less than a maximum value of an amount by which the beveled region is recessed relative to the tread profile.

8. The pneumatic tire according to claim 1 wherein a maximum value of an amount by which the beveled region is recessed relative to the tread profile is greater than a maximum value of an amount by which the protruding region protrudes from the tread profile.
